(19) United States
(12) Patent Application Publication
(10) Pub. No.: US 2010/0276397 A1
(43) Pub. Date: Nov. 4, 2010

(54) ELECTRICALLY ISOLATED GAS CUPS FOR PLASMA TRANSFER ARC WELDING TORCHES, AND RELATED METHODS

(75) Inventor: David Keith Luce, Splendora, TX (US)

Correspondence Address: TRASKBRITT, P.C., P.O. BOX 2550, SALT LAKE CITY, UT, 84110, US

(73) Assignee: BAKER HUGHES INCORPORATED, Houston, TX (US)

(21) Appl. No.: 12/433,986

(22) Filed: May 1, 2009

(51) Int. Cl. B23K 9/00; B23K 35/38; B23P 11/00

(52) U.S. Cl. 219/74; 219/121.45; 29/428

(57) ABSTRACT

Electrically isolated gas cups for plasma transferred arc welding torches, plasma transferred arc welding torches including such gas cups, and related methods are disclosed. In one embodiment a gas cup includes a dielectric portion sized and configured to couple with a torch body and electrically isolate the gas cup from the torch body. In additional embodiments, a plasma transferred arc welding torch includes an anode, a cathode, a torch body coupled to the anode and the electrode, and a gas cup at least partially surrounding the anode and electrically isolated from the torch body. In further embodiments, a method of coupling a gas cup to a plasma transferred arc welding torch includes coupling a dielectric structure to a gas cup and coupling the dielectric structure to a torch body to electrically isolate the gas cup from the torch body.

### TECHNICAL FIELD

Embodiments of the invention relate to plasma transfer arc welding and, more particularly, to plasma transfer arc welding torches, electrically isolated gas cups, and related methods.

### BACKGROUND

Plasma transfer arc (PTA) welding is an advanced variation of the tungsten inert gas (TIG) welding process. PTA welding is well-suited for automated applications, when compared to TIG welding, as the arc generated by PTA welding tends to be more consistent and less sensitive to variations in the size of the gap between the electrode and the work piece. However, when the gas cup is contacted with the work piece an electrical circuit may be formed between the torch body and the gas cup that may be detrimental to the welding process, may damage the welding torch, and may cause defects in the work piece. In view of this, automated welding of certain work pieces, such as earth boring drill bits, may be difficult as the shape of the work piece may be complex and the gas cup of the PTA welding torch may unintentionally contact the work piece during welding operations, such as hardfacing operations, and may damage the PTA torch and the work piece. Additionally, molten metal spatter from the welding process may contact the gas cup of the welding torch and may stick to the surface of the gas cup and may disrupt the gas flow from the welding torch, which may be detrimental to the welding process and require cleaning and repair of the welding torch to correct.

In view of the foregoing, it would be advantageous to provide improved PTA welding torches, gas cups for PTA welding torches, and related methods.

### BRIEF SUMMARY

In some embodiments, a gas cup for a plasma transferred arc welding torch includes a dielectric portion sized and configured to couple with a torch body and electrically isolate the gas cup from the torch body.

In additional embodiments, a plasma transferred arc welding torch includes an anode comprising a central cavity, a cathode positioned at least partially within the central cavity of the anode, a torch body coupled to the anode and an electrode, and a gas cup at least partially surrounding the anode and electrically isolated from the torch body.

In further embodiments, a method of coupling a gas cup to a plasma transferred arc welding torch includes coupling a dielectric structure to a gas cup and coupling the dielectric structure to a torch body to electrically isolate the gas cup from the torch body.

### BRIEF DESCRIPTION OF THE DRAWINGS

FIG. 1 shows a cross-sectional view of a portion of a plasma transfer arc welding torch including an electrically isolated gas cup, according to an embodiment of the present invention.

FIG. 2 shows a cross-sectional detail view of a portion of an electrically isolated gas cup including a dielectric coupler and a coolant channel, according to an embodiment of the present invention.

FIG. 3 shows a cross-sectional detail view of a portion of an electrically isolated gas cup including a dielectric coupler having an integrated coolant channel, according to an embodiment of the present invention.

FIG. 4 shows a cross-sectional detail view of a portion of an electrically isolated gas cup including a dielectric material coating thereon, according to an embodiment of the present invention.

FIG. 5 shows a cross-sectional detail view of a portion of an electrically isolated gas cup having a body formed of a dielectric material, according to an embodiment of the present invention.

FIG. 6 shows a cross-sectional detail view of a portion of a plurality of metal rings for forming coolant channels, such as included with the electrically isolated gas cup of FIG. 1.

FIG. 7 shows a perspective top view of a metal ring of FIG. 6.

FIG. 8 shows a cross-sectional view of a portion of a plasma transfer arc welding torch, such as shown in FIG. 1, during a welding operation.

### DETAILED DESCRIPTION

Illustrations presented herein are not meant to be actual views of any particular plasma transfer arc welding torch, but are merely idealized representations which are employed to describe the present invention. Additionally, elements common between figures may retain the same numerical designation. The various drawings depict embodiments of the invention as will be understood by the use of ordinary skill in the art and are not necessarily drawn to scale.

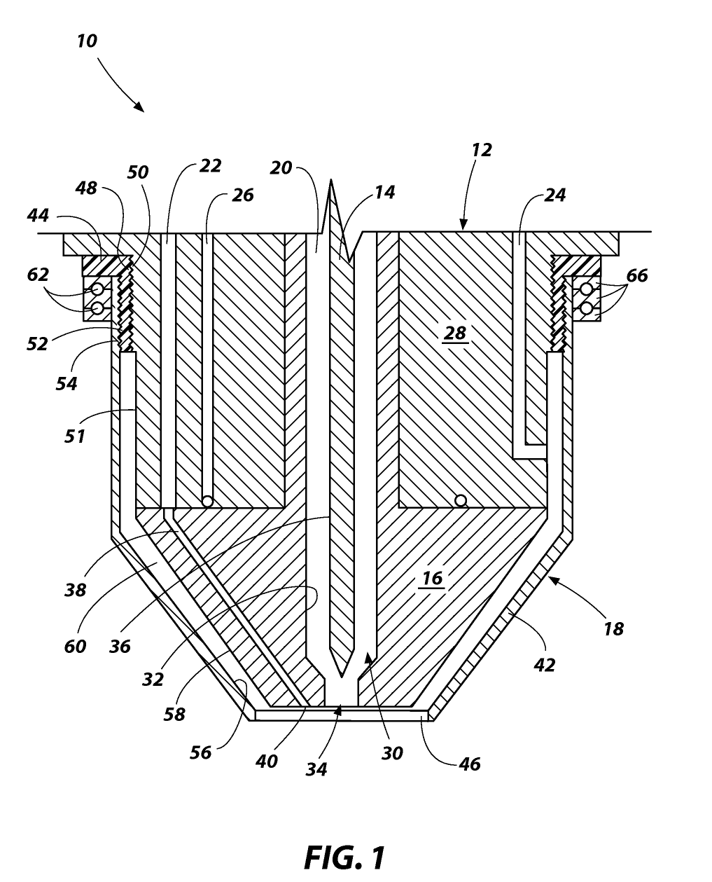

As shown in FIG. 1, a plasma transfer arc (PTA) welding torch 10 may include a torch body 12, an electrode 14, an anode 16 and a gas cup 18. The torch body 12 may be coupled to each of the electrode 14, the anode 16 and the gas cup 18, and may include a plurality of fluid channels extending therethrough, including a plasma-gas channel 20, a powder-gas channel 22, a shielding-gas channel 24, and a coolant channel 26.

The electrode 14 may be formed of an electrically conductive material with a relatively high melting point, such as tungsten, and may be generally shaped as an elongated cylinder with a conical point at one end. The end opposite the conical point may be electrically coupled to a power source and rigidly fixed to an upper portion (not shown) of the torch body 12.

The anode 16 may be formed of an electrically conductive material, such as a copper alloy, and may be electrically coupled to, and rigidly fixed to, a lower portion 28 of the torch body 12. The anode 16 may include a central cavity 30 formed therein, the central cavity 30 defined by an inner wall 32 of the anode 16. The central cavity 30 may extend to an open end of the anode 16 that may form a central nozzle 34. The electrode 14 may be positioned within the central cavity 30 of the anode 16 and electrically isolated from the anode 16. An outer surface 36 of the electrode 14 and the inner wall 32 of the anode 16 may define an annular plasma gas channel therebetween. The anode 16 may also include a powder-gas channel 38 formed therein that may be coupled to the powder-gas channel 22 of the torch body 12 and may extend to one or more openings 40 located proximate to the central nozzle 34.

In some embodiments, as shown in FIGS. 1, 2 and 3, the gas cup 18 may include a generally annular metallic body 42 coupled to a generally annular dielectric portion, such as a dielectric coupler 44, at one end and having an opening at another end forming a shielding-gas nozzle 46. The dielectric coupler 44 may be formed of a heat resistant dielectric material, such as one or more of a phenolic resin composite (i.e., BAKELITE®), thermoset plastic (i.e., Nylon and TEFLON®) and ceramic (i.e., BaSrTi) dielectric material, and may be sized and configured to couple to the lower portion 28 of the torch body 12 and may couple the gas cup 18 to the torch body 12. In view of this, the dielectric coupler 44 may electrically isolate the gas cup 18 from the torch body 12 and the anode 16.

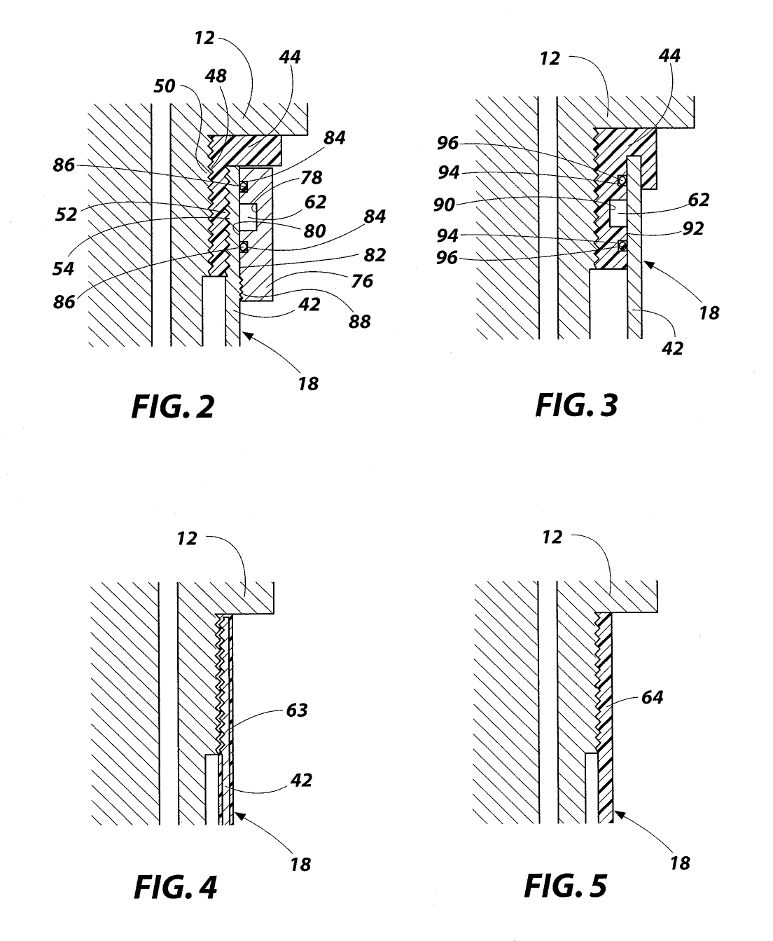

As shown in FIGS. 1 and 2, the dielectric coupler 44 may be coupled to the metallic body 42 of the gas cup 18 and to the torch body 12 with helical threads. For example, the dielectric coupler 44 may include an inner threaded portion 48, which may mate with threads 50 formed on the outer surface 51 of the torch body 12, and an outer threaded portion 52, which may mate with threads 54 formed on the inner surface 56 of the metallic body 42 of the gas cup 18. However, in additional embodiments the dielectric coupler 44 may be coupled to the metallic body 42 of the gas cup 18 by other coupling means. For example, the dielectric coupler 44 may be coupled to the metallic body 42 by a friction or interference fit, as shown in FIG. 3. In additional embodiments, the dielectric coupler 44 may be integrally molded to the metallic body 42 or may be adhered to the metallic body 42 by an adhesive. Likewise, the dielectric coupler 44 may be coupled to the torch body 12 by a coupling means other than, or in addition to, a threaded connection.

An inner surface 56 of the metallic body 42 of the gas cup 18 and an outer surface 58 of the anode 16 may define a generally annular shielding-gas channel 60 therebetween, and the generally annular shielding-gas channel 60 may be in fluid communication with the shielding-gas channel 24 of the torch body 12 and may extend to the shielding-gas nozzle 46. Additionally, the gas cup 18 may also include at least one coolant channel 62, which may be coupled to a cooling system (not shown) of the PTA welding torch 10 and may be electrically isolated from the torch body 12 and the anode 16.

In additional embodiments, as shown in FIG. 4, the gas cup 18 may comprise a metallic body 42 that may include a dielectric material coating 63 disposed thereon. The dielectric material coating 63 may extend over at least a portion of the metallic body 42, and may be positioned between the metallic body 42 of the gas cup 18 and the torch body 12. In view of this, the dielectric material coating 63 may electrically isolate the gas cup 18 from the torch body 12.

In yet further embodiments, as shown in FIG. 5, the gas cup 18 may not include a metallic body 42 and may consist essentially of a dielectric material. For example, the gas cup 18 may be composed entirely of a dielectric material, such as a ceramic dielectric material 64.

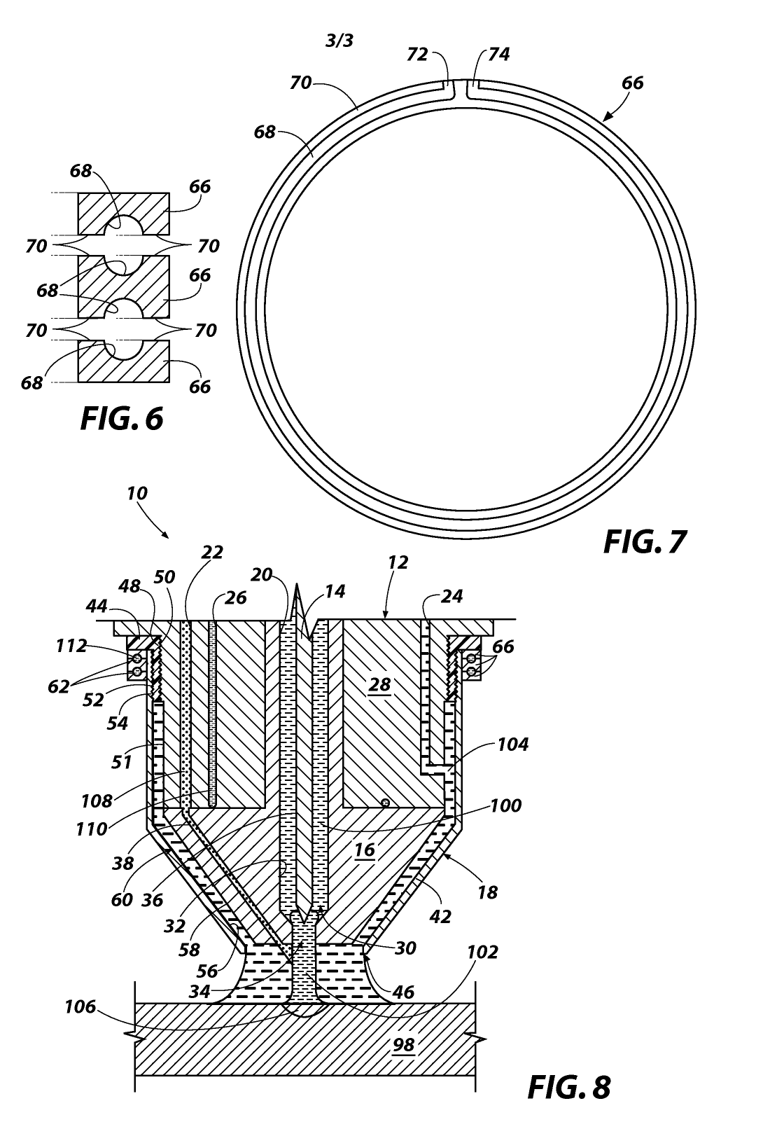

As shown in FIGS. 1, 6, 7 and 8, coolant channels 62 may be located at interfaces between a plurality of generally annular metallic structures, such as metal rings 66, which may be coupled to the metallic body 42 of the gas cup 18. Each ring 66 may include a groove 68 formed therein, and may have a surface 70 that is shaped and configured to mate with a surface 70 of another ring 66. Each ring 66 may be welded to another ring 66, such as by providing a soldering material at an interface between the mating surfaces 70 of the rings 66 and soldering the rings 66 together. Additionally, the rings 66 may be joined to the metallic body 42 of the gas cup 18, such as by soldering. The grooves 68 may then define coolant channels 62 having at least one coolant inlet 72 and at least one coolant outlet 74 (FIG. 7).

In another embodiment, as shown in FIG. 2, the coolant channel 62 may be formed in a single, generally annular structure, such as a metallic ring 76. Additionally, the ring 76 may be configured to be removed and replaced with relative ease. The ring 76 may include a groove 78 formed in an inner surface 80 that mates with a portion of an outer surface 82 of the metallic body 42 of the gas cup 18 to define the coolant channel 62. In view of this, the coolant may be directed into contact with the metallic body 42 of the gas cup 18. The ring 76 may also include grooves 84 formed in the inner surface 80, positioned on either side of the coolant channel 62, sized and configured to receive a seal, such as a gasket 86 (i.e., an -O-ring), which may assist in containing a fluid coolant within the coolant channel 62. Mating features, such as interlocking threads 88, may be formed in the ring 76 and the outer surface 82 of the metallic body of the gas cup 18 to couple the ring 76 to the metallic body 42. Additional embodiments may not include threads 88, and the ring 76 may be retained on the metallic body 42 by friction between the gaskets 86, and the outer surface 82 of the metallic body 42.

In some embodiments, as shown in FIG. 3, the coolant channel 62 may be formed in the dielectric coupler 44 located between the metallic body 42 of the gas cup 18 and the torch body 12. A groove 90 may be formed in a surface 92 of the dielectric coupler 44 that mates with the inner surface 56 (FIG. 1) of the metallic body 42 of the gas cup 18 to define the coolant channel 62. Additional grooves 94 may formed in the surface 92 of the dielectric coupler 44, positioned on either side of the coolant channel 62, sized and configured to receive a seal, such as a gasket 96 (i.e., an -O-ring), which may assist in containing a fluid coolant within the coolant channel 62. In such embodiments, an inlet and an outlet may be located within the dielectric coupler 44 to direct coolant into and out of the coolant channel 62, or an inlet and outlet may be formed through the metallic body 42. However, in some embodiments, such as shown in FIGS. 4 and 5, the gas cup 18 may not include a coolant channel 62.

Additionally, existing PTA welders may be retroactively modified according to the present invention. A conventional PTA welding torch includes a metal gas cup that is in electrical communication with a torch body and an anode of the PTA torch (not shown). The metal gas cup may be removed from the torch body, and an electrically isolated gas cup 18 according to the present invention, such as those described with reference to each of FIGS. 1-5, may be installed onto the PTA welding torch. For example, a dielectric coupler 44 may be coupled to the metal gas cup, and the dielectric coupler 44 may be coupled to the torch body to electrically isolate the gas cup from the torch body. Additionally, a coolant channel 62 may be added to the gas cup and a cooling system may be coupled to the coolant channel 62 of the gas cup. In another example, the electrically conductive metal body of the gas cup may be coated with a dielectric material coating 63 and then the gas cup may be installed on the torch body. In view of this, the dielectric material coating 63 may electrically isolate the metallic body of the gas cup from the torch body.

In operation, the central nozzle 34 of the anode 16 of the PTA welding torch 10 may be positioned proximate a work piece 98, as shown in FIG. 8. An inert gas, such as commercially pure argon 100, may be directed through the central cavity 30 of the anode 16 toward the central nozzle 34. Then a pilot arc may be ignited between the electrode 14 and the anode 16 and an electric current may pass through the argon 100 to form a plasma 102, which may exit through the central nozzle 34 of the anode 16. Additionally, a shielding-gas 104, such as argon or a gas mixture (i.e., argon and hydrogen), may be directed through the shielding-gas channel 22 of the torch body 12 and into the generally annular shielding-gas channel 60 defined between the inner surface 56 of the gas cup 18 and the outer surface 58 of the anode 16. The shielding-gas 104 may exit the shielding-gas nozzle 46 of the gas cup 18 and may substantially surround the plasma 102 that is exiting the central nozzle 34 of the anode 16. The plasma 102 exiting the central nozzle 34 of the anode 16 may then come into contact with the work piece 98 and the plasma 102 may carry an electric current from the electrode 14 to the work piece 98 and a molten weld pool 106 may be formed in the work piece 98. Additionally, a powder-gas 108, comprising a powdered material suspended in a gas, may be directed through the powder-gas channel 22 of the torch body 12 into the powder-gas channel 38 of the anode 16 and may exit the powder-gas channel 38 proximate the central nozzle 34 of the anode 16. The powdered material suspended in the powder-gas 108 may be directed into the work piece 98 and may contact the molten weld pool 106 and become fused with the work piece 98 as the weld pool 106 cools and hardens. For example, such a welding process may be utilized by an automated machine, such as a robotic arm, to apply a hardfacing material, such as a powdered metal or a powdered composite material, to an earth-boring tool, such as an earth-boring drill bit. In view of this, unintentional contact between the gas cup 18 and the work piece 98 would not create an electric circuit between the torch body 12 and the work piece 98 through the gas cup 18 that may damage the PTA welding torch 10, disrupt the welding process and cause defects in the work piece 98.

Such welding processes may generate a relatively large amount of heat. In view of this, a coolant system may be utilized to cool components of the PTA welding torch 10. During operation a coolant 110 may be directed through the coolant channel 26 in the torch body 12 to draw heat from the torch body 12 and cool the torch body 12. Additionally, as the anode 16 may be in direct contact with the torch body 12, or may be in close proximity to the torch body 12, heat may be drawn from the anode 16 by the torch body 12. In some embodiments, the gas cup 18 may be cooled by a fluid coolant directed through one or more coolant channels 62, as described with reference to FIGS. 1-7. Cooling the gas cup 18 with a coolant channel 62 that is integrated with the gas cup 18 may enable improved cooling of the gas cup 18, which may reduce the amount of molten metal spatter from the welding process that may stick to the gas cup 18 and disrupt gas flow.

In some embodiments, a dielectric coolant 112, such as shown in FIG. 8, may be directed through the coolant channel 62 of the gas cup 18, which may prevent an electric current from the PTA welding torch 10 from being carried through the coolant 112. For example, at least one of deionized water and distilled water may be directed from the cooling system into an opening of the coolant channel 62, through the coolant channel 62, and then directed out of an exit of the coolant channel 62 and returned to the cooling system. In view of this, the cooling system of the PTA welding torch 10 may include a single loop system that cycles the same coolant 110, 112 through both the coolant channel 26 of the torch body 12 and the coolant channel 62 of the gas cup 18. In additional embodiments, the cooling system may comprise two or more separate coolant loops and the coolant 110, cycled through the coolant channel 26 of the torch body 12, and the coolant 112 cycled through the coolant channel 62 of the gas cup 18, may be separate. In view of this, the gas cup 18 may be effectively cooled, which may prevent damage to the gas cup 18 and may prevent the adherence of molten metal splatter to the gas cup 18, while the gas cup 18 is electrically isolated from the torch body 12, which may prevent an electrical circuit between the work piece 98 and the torch body 12 through the gas cup 18.

Although this invention has been described with reference to particular embodiments, the invention is not limited to these described embodiments. Rather, the invention is limited only by the appended claims, which include within their scope all equivalent devices and methods.

1. A gas cup for a plasma transferred arc welding torch comprising at least a generally annular dielectric portion sized and configured to couple with a torch body and electrically isolate the gas cup from the torch body.

2. The gas cup of claim 1, further comprising a metallic body coupled to the generally annular dielectric portion.

3. The gas cup of claim 2, further comprising at least one coolant channel.

4. The gas cup of claim 2, wherein the generally annular dielectric portion comprises a dielectric material coating on the metallic body.

5. The gas cup of claim 2, wherein the generally annular dielectric portion comprises a dielectric coupler positioned at an open end of the metallic body.

6. A plasma transferred arc welding torch comprising:
an anode comprising a central cavity;
a cathode positioned at least partially within the central cavity of the anode;
a torch body coupled to the anode and an electrode; and
a gas cup at least partially surrounding the anode and electrically isolated from the torch body.

7. The plasma transferred arc welding torch of claim 6, wherein the gas cup comprises a dielectric material located between the gas cup and the torch body.

8. The plasma transferred arc welding torch of claim 7, wherein the gas cup consists essentially of a dielectric material.

9. The plasma transferred arc welding torch of claim 7, wherein the gas cup comprises a metallic body.

10. The plasma transferred arc welding torch of claim 9, wherein the dielectric material comprises a dielectric coating on at least a portion of the metallic body.

11. The plasma transferred arc welding torch of claim 9, wherein the dielectric material comprises a generally annular dielectric coupler positioned at an open end of the metallic body.

12. The plasma transferred arc welding torch of claim 6, further comprising a cooling system and wherein the gas cup further comprises a coolant channel coupled to the cooling system.

13. The plasma transferred arc welding torch of claim 12, wherein the cooling system comprises a dielectric fluid coolant.

14. The plasma transferred arc welding torch of claim 13, wherein the dielectric fluid coolant comprises at least one of deionized and distilled water.

15. The plasma transferred arc welding torch of claim 12, wherein the coolant channel is positioned and configured to direct a coolant flow into direct contact with a major body of the gas cup.

16. The plasma transferred arc welding torch of claim 15, wherein the coolant channel comprises a generally annular coolant structure sealed to the major body of the gas cup with at least one gasket.

17. The plasma transferred arc welding torch of claim 12, wherein the coolant channel is located at an interface between generally annular metallic structures.

18. The plasma transferred arc welding torch of claim 12, wherein the coolant channel is located at least in part within a dielectric coupler that electrically isolates the gas cup from the torch body.

19. A method of coupling a gas cup to a plasma transferred arc welding torch, the method comprising:
coupling a dielectric structure to a gas cup; and
coupling the dielectric structure to a torch body to electrically isolate the gas cup from the torch body.

20. The method of claim 19, wherein coupling a dielectric structure to a gas cup comprises forming a dielectric material layer on a metallic body of the gas cup.

21. The method of claim 19, further comprising coupling a cooling system to a coolant channel of the gas cup.
